(19) United States
(12) Patent Application Publication
(10) Pub. No.: US 2007/0145882 A1
(43) Pub. Date: Jun. 28, 2007

(54) Light-emitting diode emitting uniformly light all around

(76) Inventor: Peixin Xu, Zhuhai (CN)

Correspondence Address: HDSL, 4331 STEVENS BATTLE LANE, FAIRFAX, VA, 22033, US

(21) Appl. No.: 10/554,876

(22) PCT Filed: Apr. 28, 2004
(86) PCT No.: PCT/CN04/00416

§ 371 Date: Oct. 10, 2006

(30) Foreign Application Priority Data
Apr. 30, 2003 (CN) 03225716.3

(51) Int. Cl. H01J 1/62; H01J 63/04

(52) U.S. Cl. 313/498

(57) ABSTRACT

A light-emitting diode which emits light uniformly emitted all around is provided. The present invention comprises a light emitting diode (LED) die, a transparent envelop body and a connection pin, which is characterized in that the envelop body is a cylindrical body and a top surface of the envelop body being indented to form a semi-spherical recess or, a conic concave or a polygonal concave with a tip angle between 100° to 140°. Since the present invention uses a structure which the top of the envelop body is disposed as a inward concave shape with the tip angle between 100° to 140° or semi-spherical recess shape, it skillfully makes use of the optical spreading characteristic of the inward concave body. Which makes light beam which is emitted by the light emitting diode die emit uniformly all around the envelop body via refraction of a plurality of the sides of the inward concave body. At the same time, in order to further enhance its decorative, said envelop body is set to different colour coloured body. Therefore, it may emit light all around, and which has a simple structure, easy to manufacture, low manufacturing cost, good decorative effect. Thus, it can be applied to in the field of all sorts of new type lamps.

### BACKGROUND OF THE INVENTION

1. Field of Invention

The present invention relates in general to a light-emitting diode (LED), and more particular, to a light-emitting diode operative to emit uniform light to the ambient thereof.

2. Related Art

The further technical advancement and the inherent features such as low driving voltage, low heat, and uneasily broken structure have acquired broader application in various types of lighting devices, particularly the decorative lamps. The commonly used light-emitting diode includes a light-emitting diode die encapsulated within a transparent or translucent casing. The casing is configured to provide converging effect. Therefore, the light is typically concentrated within a narrow viewing angle. The light is very dim for the observer positioning beyond the narrow viewing angle. To resolve the narrow viewing angle problem, different configurations of the casing such as wedge or polygonal have been proposed. The configuration with wedged surface allow the light generated by the light-emitting diode to reflect towards specific angle. However, the majority of light is still concentrated upfront. The lateral light is still very limited. In Chinese Patent No. ZL98248949, glass beads are added within the casing for a light-emitting diode envelop body to cause the light reflected laterally. However, as the density of the glass beads is different from that of epoxy used for fabricating the casing, the glass beads are often non-uniformly distributed within the casing to result in non-uniform light. In addition, this type of light-emitting diode device is laborious and more costly.

### SUMMARY OF THE INVENTION

A light-emitting diode device is provided to generate uniform light with large viewing angle. The light-emitting as provided has a simple structure, such that the process complexity and cost are greatly reduced.

The light-emitting diode device of the present invention is fulfilled as follows.

The light-emitting diode device includes a light-emitting diode die, a transparent envelop body, a connection pin, which is characterized in that the envelop body is a cylindrical body and the top of the envelop body forms a conic or a polygonal concave with an angle around 100° to 140°.

To optimize the best light deflecting and reflecting effect, the angle of the smooth cone is around 130° to 140°.

In another embodiment, the envelop body is a cylindrical body and the top of the envelop body forms a semi-spherical recess.

Color envelop body can be used to provide desired visual effect.

By configuring the indented top surface of the envelop body into the inward concave or the semi-spherical recess structure, the light generated by the light-emitting diode die is properly deflected, reflected and diffused into a uniform light emitted with a wide angle. The cylindrical body and the indented top surface can be easily fabricated with much lower cost. More important, the light-emitting diode device adapting such envelop body is operative to generate light propagating both forwardly and laterally, such that the observer at the side of the light-emitting diode device can easily observes the light generated thereby, while the observes right in front of the light-emitting diode device will not be dashed by the concentrated light.

### BRIEF DESCRIPTION OF THE DRAWINGS

The present invention will become more fully understood from the detailed description given hereinbelow illustration only, and thus are not limitative of the present invention, and wherein:

FIG. 1 shows a perspective view of a light-emitting diode device according to the present invention;

FIG. 2 shows a top view of the light-emitting diode device as shown in FIG. 1;

FIG. 3 shows a cross sectional view of the light-emitting diode device along the A-A line in FIG. 2;

FIG. 4 shows the propagation of light generated by the light-emitting diode device; and

FIG. 5 shows a light-emitting diode device includes various color light-emitting diode dies to emit blue or white color of light.

### DETAILED DESCRIPTION OF THE INVENTION

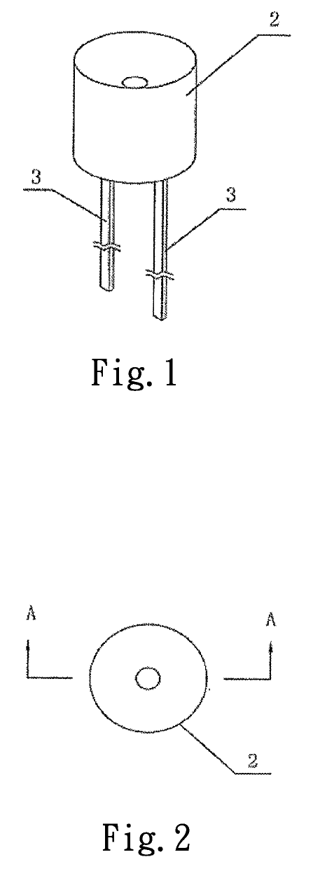

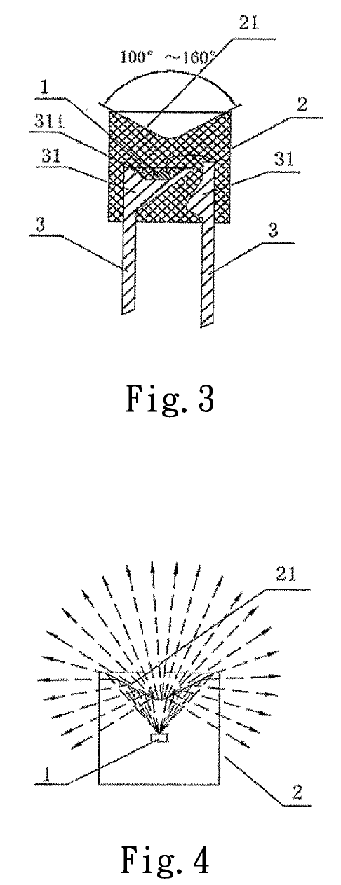

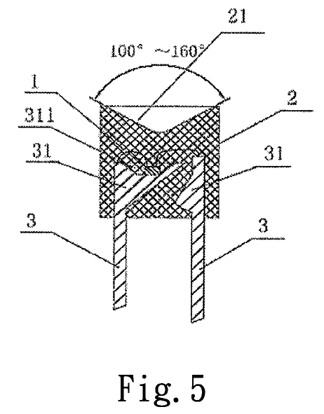

As shown in FIGS. 1 and 3, the light-emitting diode device includes a light-emitting diode die 1, connection pins 3 and a transparent envelop body 2 for encapsulating the light-emitting diode die 1 therein. The connection pins 3 extend from the light-emitting diode die 1 through the envelop body 2 to provide electric connection to an external device such as a power source. The envelop body 2 can be fabricated from epoxy, for example. As shown, the internal ends of connection pins 3 are terminated with electrode frames 31 to prevent the connection pins 3 separately from engaging with the envelop body 2. The electrode frames 31 form a recessed space 311 for accommodating the light-emitting diode die 1 therein to provide more forward focused light beam. The frames 31 include conductive wires for connecting the light-emitting diode die 1. As shown in FIG. 4, in order to satisfy user's need to emit light uniformly all around and to enhance decorative effects, the envelop body 2 is a cylindrical body with the top surface being indented as a conic concave 21 or a polygonal concave with a tip angle between 100° to 140° . Alternatively, the top surface can be indented into a semi-spherical recess. It skillfully makes use of the optical spreading characteristic of the concave so that light beam straightly emitted by the light emitting diode die 1 toward the envelop body 2 will uniformly emit all around the envelop body 2 via refraction of a plurality of the sides of the inward concave. As shown in FIG. 3, to ensure the better performance, a curvature of the concave 21 can not be too small or too large; otherwise, light beam straightly emitted from the light emitting diode die 1 will direct forwardly without sufficient light deflecting, reflecting and diffusing all around so that the lighting effect of the present invention is reduced. Therefore, the tip angle of the conic concave is between about 100° to 160°, peferably, about 130° to about 140° to optimize the uniformity. Further, the envelop body 2 can be made with various colors to provide desired visual effect. FIG. 3 shows the structure for the light-emitting diode device which provides any color of light except for blue or white color. FIG. 5 shows a modification of the light-emitting diode device in which more than one light emitting diode dies are installed to generate blue or white color of light. Accordingly, it can emit light all around, and which has a simple structure, easy to manufacture, low manufacturing cost, good decorative effect. Thus, it can be applied to in the field of all sorts of new type lamps.

What is claimed is:

1. A light-emitting diode device, comprising a light-emitting diode die, a connection pin and a transparent envelop body, characterized in that the envelop body is a cylindrical body and a top surface of the envelop body being indented to form a conic concave or a polygonal concave with a tip angle between 100° to 140°.

2. The device of claim 1, wherein the tip angle is 130° to 140°.

3. The device of claim 1, wherein the envelop body has a color substantially the same as that of the light generated by the light-emitting diode die.

4. The device of claim 1, wherein the connection pin has an internal end terminated with a frame for holding the light-emitting diode die and the frame forms a recessed space for accommodating the light-emitting diode die therein.

5. A light-emitting diode device, comprising a light-emitting diode die, a connection pin and a transparent envelop body, characterized in that the envelop body is a cylindrical body and a top surface of the envelop body being indented to form a semi-spherical recess.

6. The device of claim 5, wherein the envelop body has a color substantially the same as that of the light generated by the light-emitting diode die.

7. The device of claim 5, wherein the connection pin has an internal end terminated with a frame for holding the light-emitting diode die and the frame forms a recessed space for accommodating the light-emitting diode die therein.
